(19) United States
(12) Patent Application Publication
(10) Pub. No.: US 2008/0196267 A1
(43) Pub. Date: Aug. 21, 2008

(54) Washing machine and method for controlling the same

(75) Inventors: Jee Hun Park, Suwon-si (KR); Sang Yeon Pyo, Suwon-si (KR); Jae Ryong Park, Hwaseong-si (KR); Sung Hoon Kim, Suwon-si (KR); Eun Suk Bang, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/005,358

(22) Filed: Dec. 27, 2007

(30) Foreign Application Priority Data
Feb. 16, 2007 (KR) 10-2007-16860

(51) Int. Cl. F26B 3/02; D06F 37/02; F26B 11/02; F26B 19/00

(52) U.S. Cl. 34/443; 68/5 C; 34/132; 34/549

(57) ABSTRACT

A washing machine, and a method to control same, prevents deposition of scale in a steam generator and removes deposited scale effectively. The washing machine, which has a rotary drum, a steam generator having a generator heater to supply steam to an inside of the rotary drum, and a water supply device to supply water to the steam generator, includes a control unit controlling the water supply device to allow water to pass intermittently through the steam generator to cool the steam generator when operation of the steam generator is terminated.

### CROSS-REFERENCE TO RELATED APPLICATIONS

This application claims the benefit of Korean Patent Application No. 2007-0016860, filed Feb. 16, 2007, in the Korean Intellectual Property Office, the disclosure of which is incorporated herein by reference.

### BACKGROUND

1. Field

The present invention relates to a washing machine, and more particularly, to a washing machine having a steam generator for supplying steam to the inside of a rotary drum.

2. Description of the Related Art

Generally, washing machines (usually, drum washing machines) are apparatuses, which include a tub containing water and a rotary drum rotatably installed in the tub, and thus wash laundry, put into the rotary drum, due to power generated due to the lifting and dropping of the laundry by rotating the rotary drum. Among these washing machines, there are washing machines which include a steam generator for injecting hot steam to the inside of the rotary drum to improve washing power.

Such a steam generator includes a steam generation channel having a designated flow space, in which water flows, a water supply channel for supplying water to the flow space of the steam generation channel, a heater for heating the water flowing to the flow space of the steam generation channel, and a discharge channel for discharging the steam generated by heating the water using the heater.

Extremely small amounts of minerals or salts contained in water are stuck to the surface of the wall of the steam generator, thus generating scale. When the scale is deposited on the surface of the wall of the steam generator, the sectional areas of the channels of the steam generator are decreased, and the heat conductivity of the steam generator is lowered so that the steam generator has low heat exchange efficiency.

To solve the above problems, Korean Patent Laid-open Publication No. 10-2006-0102963 discloses a method to control a steam washing procedure of a drum washing machine, in which steam is supplied to the inside of a drum. The method includes supplying steam to the inside of the drum by heating a steam generator to increase a temperature of the inside of the drum in the steam washing procedure, and supplying washing water to the steam generator for washing the steam generator during the supplying of the water to a tub in a rinsing operation after the steam washing procedure.

The above patent discloses a process for continuously supplying the washing water to the steam generator for washing the steam generator. However, in the case that water having a greater than average hardness is used, a scale removal effect is lowered.

When the heater is turned on to generate steam and then turned off, the temperature of the heater is gradually decreased. In the case that water is maintained at an above average temperature, scale is apt to be deposited on a heat source. Accordingly, while the temperature of the heater is gradually decreased, i.e., the water in the heater is maintained at an above average temperature, scale is deposited on the surface of the wall of the steam generator.

To remove the deposited scale, in the above conventional method, washing water passes through the steam generator for washing the steam generator when rinsing water is supplied. Here, since the same water supply pipe and valve for heating and washing the steam generator are used, the washing water cannot be supplied at a pressure that is elevated enough to remove the scale. Accordingly, the scale removal effect is insufficient.

That is, it is necessary that an extremely small amount of water be supplied to heat the steam generator to completely generate steam, but a predetermined elevated amount of water at an elevated pressure is supplied to effectively remove scale. However, the above patent does not disclose any structure or method to solve this problem.

### SUMMARY

Therefore, one aspect of the present invention is providing a washing machine to prevent the deposition of scale in a steam generator and effectively removing the deposited scale, and a method to control the same.

In accordance with one aspect, the present invention provides a washing machine, which has a rotary drum, a steam generator provided with a generator heater to supply steam to an inside of the rotary drum, and a water supply device to supply water to the steam generator, including a control unit controlling the water supply device so that water intermittently passes through the steam generator to cool the steam generator when the operation of the steam generator is terminated.

The water supply device may include water supply pipes connecting the steam generator and a water supply source, and water supply valves arranged to open and close the water supply pipes; and the control unit may turn on and off the water supply valves alternately.

The water supply pipes may be provided in a pair, and be united and connected to the steam generator.

The control unit may turn off the generator heater when the operation of the steam generator is terminated.

The water supply valves may be respectively provided to the water supply pipes in a pair, and may have different opening degrees.

The steam generator may include a steam generation channel, through which water passes to generate the steam, and the steam generation channel may be made of Teflon®.

The control unit may turn off the water supply valve that has a larger opening degree in the pair of water supply valves when the steam generator is operated.

The control unit may turn on both the water supply valves in a pair or the water supply valve having the larger opening degree in the pair of water supply valves when the steam generator is cooled.

In accordance with another aspect, the present invention provides a washing machine, which includes a water supply device, a rotary drum, and a steam generator to supply steam to the inside of the rotary drum, wherein the steam generator includes a steam generation channel, through which water passes to generate the steam, a generator heater to evaporate the water in the steam generation channel, and a control unit turning off the generator heater and turning on/off the water supply device to supply water intermittently to the steam generation channel to prevent the deposition of scale in the steam generation channel.

In accordance with yet another aspect, the present invention provides a method to control a washing machine which has a rotary drum, and a steam generator provided with a generator heater to supply steam to the inside of the rotary drum, the method comprising performing a steam supplying operation to supply the steam, which is generated by operating the steam generator, to the rotary drum; and performing a channel washing operation to supply water intermittently to the steam generator, after the steam supply operation is terminated, to prevent the deposition of scale on the steam generator.

The channel washing operation may include turning off the generator heater.

Water supply valves may be alternately turned on and off in the channel washing operation.

Water supply pipes in a pair may be united and connected to the steam generator to supply water to the steam generator, and water supply valves having different opening degrees in a pair may be respectively provided in the water supply pipes. In addition, the water supply valve having a smaller opening degree in the pair of water supply valves may be turned on so that water passes through the steam generator in the steam supplying operation.

Both the water supply valves in a pair or the water supply valve having a larger opening degree in the pair of water supply valves may be turned on so that water passes through the steam generator in the channel washing operation.

The channel washing operation may be performed when the water for rinsing is supplied.

The channel washing operation may be performed before a washing operation is terminated.

Water may pass through the steam generator at a higher pressure in the channel washing operation than the pressure in the steam supplying operation.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a sectional view of a washing machine in accordance with an embodiment of the present invention;

FIG. 2 is a perspective view of a steam generator of a washing machine in accordance with an embodiment of the present invention;

FIG. 3 is a control block diagram of a washing machine in accordance with an embodiment of the present invention;

FIG. 4 is a flow chart to illustrate a method to control a washing machine in accordance with one embodiment of the present invention;

FIG. 5 is a table stating a scale removal effect of the method to control the washing machine of an embodiment of the present invention, compared to a method to control a conventional washing machine; and

FIG. 6 is a flow chart to illustrate a method to control a washing machine in accordance with another embodiment of the present invention.

### DETAILED DESCRIPTION OF THE EMBODIMENTS

Reference will now be made in detail to the embodiments of the present invention, an example of which is illustrated in the accompanying drawings, wherein like reference numerals refer to like elements throughout. The embodiments are described below to explain the present invention by referring to the annexed drawings.

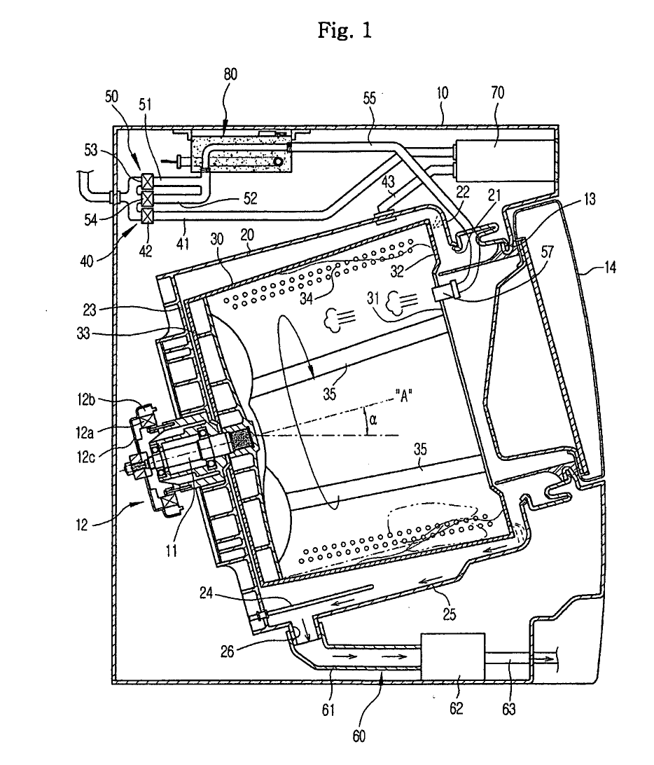

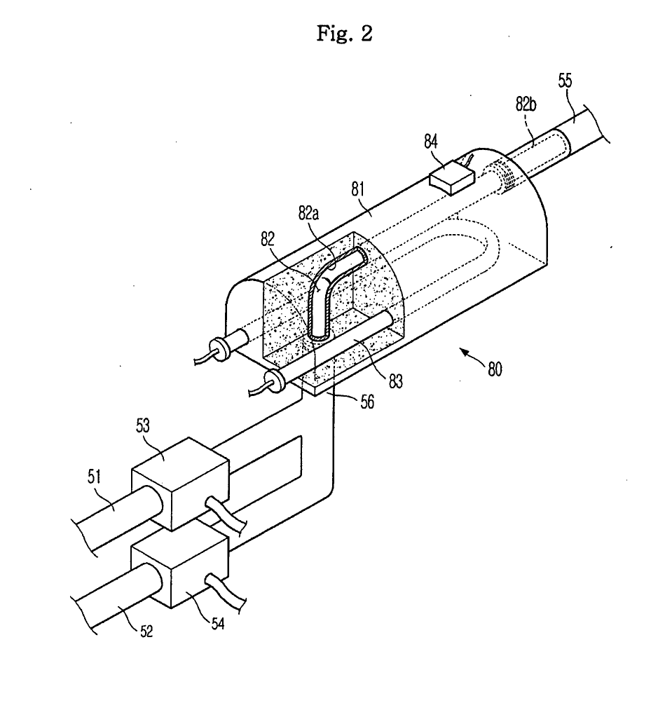

FIG. 1 is a sectional view of a washing machine in accordance with an embodiment of the present invention, and FIG. 2 is a perspective view of a steam generator of the washing machine in accordance with an embodiment of the present invention.

The washing machine of an embodiment of the present invention, as shown in FIG. 1, includes a main body 10 forming the external appearance of the washing machine, a tub 20, having a cylindrical structure, installed in the main body 10 for containing washing water, and a rotary drum 30 rotatably installed in the tub 20. The washing machine of the embodiment of FIG. 1 of the present invention further includes a water supply device 40 and 50 to supply washing water to the inside of the tub 20, a drain device 60 to discharge the washing water from the inside of the tub 20 to the outside, a detergent supply device 70 to supply a detergent, which dissolves in the washing water, to the inside of the tub 20, and a steam generator 80 to supply steam to the inside of the rotary drum 30.

The tub 20 provided in the main body 10 is inclined at a predetermined angle (α) against the installation surface of the washing machine such that a front surface 21 provided with an opening 21 is higher than a rear surface 23 of the tub. The rotary drum 30 installed in the tub 20 is inclined in the same manner as the tub 20 such that a front surface 32 provided with an opening 31 is higher than a rear surface 33 of the rotary drum.

That is, the rotary drum 30 is installed such that a central line (A) for rotation is inclined at the predetermined angle (α) against the installation surface of the washing machine under the condition the front surface 32 provided with the opening 31 faces upward. Here, since a rotary shaft 11 connected to the center of the rear surface 33 is rotatably supported by the rear central portion of the tub 20, the rotary drum 30 is rotatable in the tub 20.

A plurality of through holes 34 are formed through the circumferential surface of the rotary drum 30. A plurality of lifters 35 to lift and drop laundry when the rotary drum 30 is rotated are installed on the inner surface of the rotary drum 30.

A motor 12 serving as a driving device to rotate the rotary shaft 11 connected to the rotary drum 30 is installed at the outside of the rear surface 23 of the tub 20. The motor 12 includes a stator 12a fixed to the rear surface 23 of the tub 20, a rotor 12b rotatably disposed at the outside of the stator 12a, and a rotary plate 12c connecting the rotor 12b and the rotary shaft 11.

An opening 13 is formed through the front surface of the main body 10 at a position corresponding to the opening 31 of the rotary drum 30 and the opening 21 of the tub 20 so that laundry can be put into or taken out of the rotary drum 30, and a door 14 for opening and closing the opening 13 is installed at the front surface of the main body 10.

The detergent supply device 70 to supply a detergent to the inside of the tub 20, the steam generator 80 to supply steam in an optimum state to the inside of the tub 20, and the water supply device 40 and 50 to supply water to the tub 20 and the steam generator 80 are installed above the tub 20. The drain device 60 to discharge the water in the tub 20 is provided below the tub 20.

The detergent supply device 70 includes a space formed therein to receive the detergent, and is installed in the front surface of the main body 10 so that a user can easily put the detergent into the detergent supply device 70.

The water supply device 40 and 50 includes a first water supply unit 40 to supply washing water to the inside of the tub 20 via the detergent supply device 70, and a second water supply unit 50 to supply washing water to the inside of the rotary drum 30 via the steam generator 80.

The first water supply unit 40 includes a first water supply pipe 41 with one end connected to a water supply source and the other end connected to the detergent supply device 70, a first water supply valve 42 located in the middle of the first water supply pipe 41 to control the supply of water through the first water supply pipe 41, and a first connection pipe 43 located between the detergent supply device 70 and the tub 20 to supply the water, passed through the detergent supply device 70, to the tub 20. Accordingly, the water flowing through the first water supply pipe 41 is supplied to the inside of the tub 20 via the detergent supply device 70, thus allowing the detergent, dissolving in water, in the detergent supply device 70 to be supplied to the tub 20.

The second water supply unit 50 includes second and third water supply pipes 51 and 52 respectively provided with first ends connected to the water supply source and the other ends connected to the steam generator 80, second and third water supply valves 53 and 54 located in the middles of the second and third water supply pipes 51 and 52 to control the supply of water to the steam generator 80, and a second connection pipe 55 located between the steam generator 80 and the tub 20 to supply steam or water, passed through the steam generator 80, to the tub 2

The second and third water supply pipes 51 and 52 are united at an inlet of the steam generator 80, and connected to the steam generator 80. The second and third water supply valves 53 and 54 are located in the second and third water supply pipes 51 and 52 and have different opening degrees. The second water supply valve 53 has an opening degree sufficient to supply water in an amount of 0.3 L per minute, and third water supply valve 54 has an opening degree sufficient to supply water in an amount of 3 L per minute.

Accordingly, in the case that the steam generator 80 is operated, the second water supply valve 53 is turned on and the third water supply valve 54 is turned off so that a reduced amount of water is supplied to the steam generator 80 through the second water supply pipe 51. Thereby, the supplied water is heated and completely changed into steam. Further, in the case that a channel washing operation, which will be described below, is performed, the third water supply valve 54 is turned on or the second and third water supply valves 53 and 54 are turned on so that a large amount of water is supplied to the steam generator 80 at a high pressure through the third water supply pipe 52 or the second and third water supply pipes 51 and 52. Thereby, an increased amount of the water passes through the steam generator 80 at a high speed, and thus improves a scale prevention effect in the steam generator 80.

Although the second and third water supply valves 53 and 54 are separately provided, the present invention is not limited thereto. That is, a single water supply pipe may be connected to the steam generator, and a single water supply valve having an adjustable opening degree may be provided in the water supply pipe.

The steam generator 80, as shown in FIGS. 1 and 2, includes a housing 81, a steam generation channel 82 formed in the body 81 having an inlet connected to a united pipe 56, obtained by uniting the second and third water supply pipes 51 and 52 such that water passes through the steam generation channel 82, a U-shaped generator heater 83 buried in the housing 81 to heat the water passing through the steam generation channel 82, and a temperature sensor 84 installed at one side of the steam generator 80 to sense the temperature of the steam generator 80.

The housing 81 of the steam generator 80 is made of a metal having an effective heat transfer coefficient, so that the housing 81 is heated to an effective elevated temperature using the generator heater 83 by burying the generator heater 83 in the housing 81. When water flows along the steam generation channel 82, the water in the steam generation channel 82 is heated by the hot air of the housing 81, thus being changed into steam.

That is, a small amount of water is supplied to the steam generation channel 82 under the condition that the housing 81 is heated to an effective elevated temperature, thus being heated during the process of passing through the steam generation channel 82. Thereby, the water can be changed into a steam of an effective elevated temperature in a short time. To facilitate this process, generally, the housing 81 is a stick shape having a predetermined length, and the steam generation channel 82 is extended in a lengthwise direction of the housing 81.

An inner surface 82a or an outlet 82b of the steam generation channel 82 is made of a non-stick material, such as Teflon®. Although scale is deposited on the surface of a Teflon®-made object, the scale is not firmly bonded to the surface of the Teflon®-made object. Thus, it is easy to remove scale deposited on the surface of the Teflon®-made object through a channel washing operation, which will be described later.

The outlet 82b of the steam generation channel 82 is connected to the second connection pipe 55 so that steam or water, passed through the steam generation channel 82, flows into the tub 20 through the second connection pipe 55. A discharge nozzle 57 is located at the outlet of the second connection pipe 55.

Although the generator heater 83 installed in the steam generator 80 is described, the present invention is not limited thereto. That is, an external heater contacting the outer surface of the upper or lower portion of the steam generator 80 or a heater surrounding the outer surface of the steam generator 80 may be installed.

A heater 24 for heating washing water supplied to the inside of the tub 20 is installed in the lower portion of the inside of the tub 20. A heater reception portion 25, which receives the heater 24 and collects a designated amount of washing water simultaneously, is protruded downwardly from the lower portion of the tub 20. Thereby, the heater 24 can submerge in the washing water collected in the heater reception portion 25. The heater 24 is received in the heater reception portion 25, thus allowing the rotary drum 30 to be rotated without interfering with the heater 24.

The drain device 60 includes a first drain pipe 61 connected to a drain hole 26 formed through the heater reception portion 25 of the lower portion of the tub 20 for guiding the water in the tub 20 to the outside, a drain pump 62 installed in the first drain pipe 61, and a second drain pipe 63 connected to an outlet of the drain pump 62.

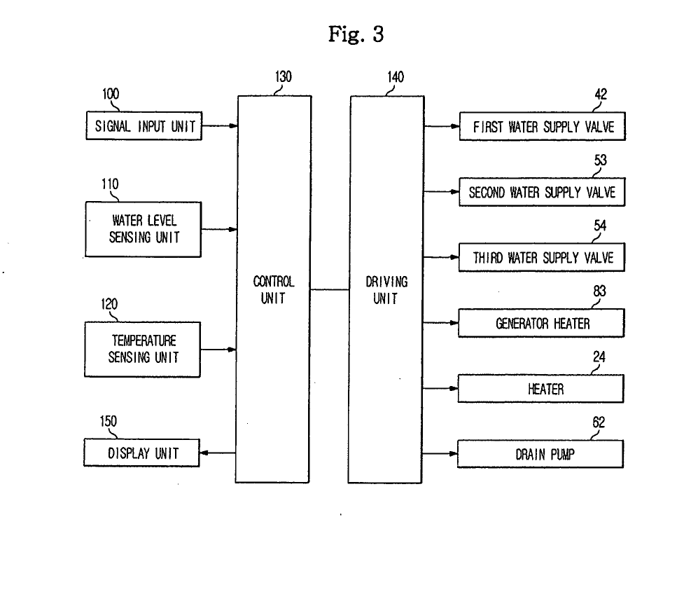

FIG. 3 is a control block diagram of a washing machine in accordance with an embodiment of the present invention. The washing machine further includes a signal input unit 10, a water level sensing unit 110, a temperature sensing unit 120, a control unit 130, a driving unit 140, and a display unit 150.

The signal input unit 100 allows a user to input operation data, such as a washing procedure, a washing temperature, a dehydrating rpm, and the addition of a rinsing operation, which are selected by the user, via the control unit 130. The water level sensing unit 110 senses the level of the washing water supplied to the tub 20. The temperature sensing unit 120 includes a temperature sensor 84 to sense the temperature of the washing water supplied to the tub 20 and the temperature of the steam generator 80.

The control unit 130 is a microcomputer, which controls the washing machine according to the operation data inputted from the signal input unit 100. The control unit 130 controls the operation of the second water supply valve 53 and the generator heater 83 according to the temperature value sensed by the temperature sensing unit 120 such that the steam generator 80 generates an effective amount of steam of a temperature of 100° C. or more.

When a steam supplying operation is terminated, the control unit 130 turns the generator heater 83 and the second and third water supply valves 53 and 54 on and off to cool the steam generator 80 to prevent the deposition of scale. Thereby, water intermittently passes through the steam generation channel 82 into the steam generator 80.

The driving unit 140 drives the first, second, and third water supply valves 42, 53, and 54, the generator heater 83, the heater 24, and the drain pump 62 according to control signals of the control unit 130.

The display unit 150 displays an operating state of the washing machine and an error mode.

Hereinafter, the operation and function of the above-described washing machine and a method for controlling the same will be described in accordance with an embodiment of the invention.

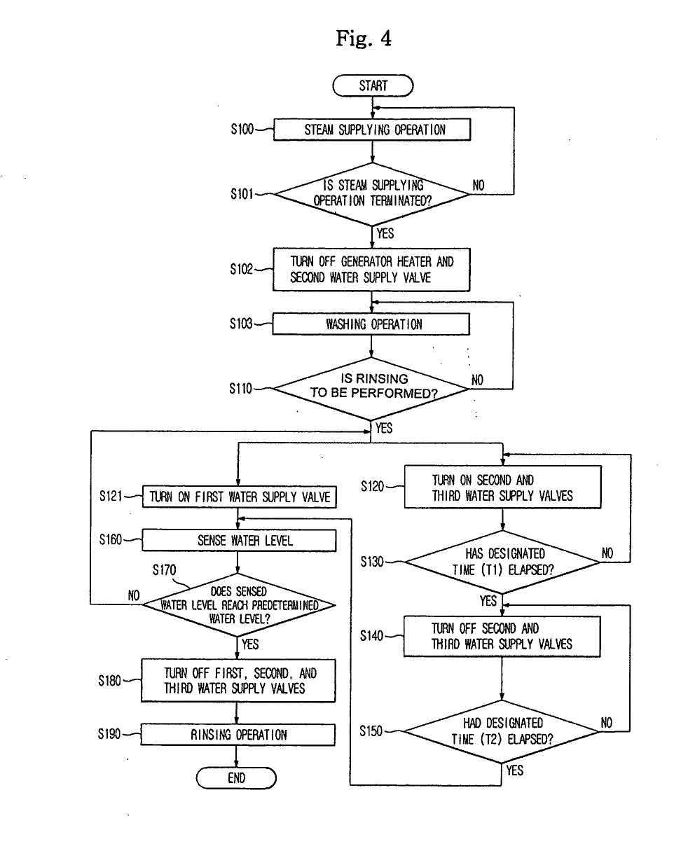

FIG. 4 is a flow chart illustrating a method of controlling a washing machine in accordance with an embodiment of the present invention. In FIG. 4, S represents a step/operation.

When a steam washing procedure is selected under the condition that laundry is put into the rotary drum 30, a detergent is supplied to the detergent supply device 70, and the washing machine is operated, the control unit 130 turns on the first water supply valve 42 to supply water to the detergent supply device 70. Then, the detergent in the detergent supply device 70 dissolves in the washing water supplied to the tub 20 via the detergent supply device, and is supplied to the tub 20.

After a designated amount of the washing water is supplied to the inside of the tub 20 through the first supply pipe 41, the control unit 130 turns off the first water supply valve 42 to stop the supply of water to the first water supply pipe 41.

After the supply of water is completed, the control unit 130 operates the heater 24 to heat the washing water filling the tub 20. When the temperature of the washing water reaches a temperature predetermined by a user, the operation of the heater 24 is stopped.

When the temperature of the supplied washing water reaches the predetermined temperature of a washing operation, the washing operation is performed. Here, a steam supplying operation is performed according to the user's selection (S100). Hereinafter, the steam supplying operation will be described.

In order to supply an effective amount of steam of a temperature of 100° C. or more to the tub 20, the control unit 130 preheats the generator heater 83 installed in the steam generator 80. Thereby, the housing 81 is preheated, and when the steam generator 80 is initially operated, the steam generator 80 rapidly generates pure steam of a normal temperature (23˜24° C.), which does not contain liquid water, and supplies the steam to the tub 20.

After the generator heater 83 is preheated, the temperature sensing unit 120 senses the temperature of the steam generator 80 due to the preheating and outputs the sensed temperature to the control unit 130. The control unit 130 compares the temperature of the steam generator 80 inputted from the temperature sensing unit 120 to a predetermined reference temperature (the lowermost temperature for generating steam due to the heating using the heater, approximately 100° C.). As a result of the comparison, when the temperature of the steam generator 80 is more than the reference temperature, the control unit 130 turns on the second water supply valve 53.

When the second water supply valve 53 is turned on, washing water is supplied to the steam generator 80 through the second water supply pipe 51. The washing water supplied to the steam generator 80 is instantly heated by the generator heater 83, thus being converted into steam of a high temperature of 100° C. or more. To obtain the optimum steam generating effect, the washing water is intermittently supplied to the steam generator 80. Thereby, the steam generator 80 is maintained at or above a predetermined temperature so that pure steam not containing liquid water is supplied to the tub 20.

The steam of the elevated temperature is sprayed to the inside of the tub 20 through the second connection pipe 55 and the discharge nozzle 57, and is supplied to laundry, which is dropped by the rotation of the rotary drum 30 during the washing operation, thereby effectively soaking the laundry and separating contaminants from the laundry, and thus improving a washing capacity.

The control unit 130 checks a steam supply time of the steam generator 80, and determines whether the steam supply time exceeds a predetermined time (generally, a steam supplying operation time selected by a user, approximately 3, 6 or 9 minutes) (S101). When it is determined that the steam supply time exceeds the predetermined time, the control unit 130 turns off the generator heater 83 and the second water supply valve (S102). Then, the washing operation is performed according to the selected washing procedure under the condition that the rotary drum 30 is rotated at a reduced speed by the motor 12 (S103).

After the washing operation is completed, the control unit 130 determines whether a rinsing operation is to be performed (S110). As a result of the determination, when the rinsing (operation) is to be performed, the supply of rinsing water and a channel washing operation (S120, S130, S140, and S150) are simultaneously performed.

In the washing machine having the steam generator 80, during the generation of steam by heating water, an extremely small amount of calcium or magnesium contained in water of an elevated temperature is transferred to a heat source of an elevated temperature, and is deposited on the inner wall of the steam generation channel 82, thus forming scale. Accordingly, the channel washing operation (S120, S130, S140, and S150), to prevent the generation of scale, is essentially required.

The channel washing operation may be performed using the third water supply valve 54. Generally, to increase a scale removal effect caused by an elevated current of water, the channel washing operation is performed using the second and third water supply valves 53 and 54.

In the same manner as a conventional washing machine, the first water supply valve 42 is turned on, and thus the rinsing water is continuously supplied to the inside of the tub 20 through the first water supply pipe 41.

Simultaneously, the second and third water supply valves 53 and 54 are turned on, and thus, the second and third water supply pipes 51 and 52 are opened (S120). The control unit 130 checks a turning-on time of the second and third water supply valves 53 and 54, and determines whether the turning-on time of the second and third water supply valves 53 and 54 exceeds a predetermined time (T1: a value variously selected from a table stored in the control unit, wherein T1 is approximately 20 seconds in the embodiment of FIG. 4) (S130). When it is determined that the turning-on time exceeds the predetermined time (T1), the control unit 130 turns off the second and third water supply valves 53 and 54 (S140).

Thereafter, the control unit 130 checks a turning-off time of the second and third water supply valves 53 and 54, and determines whether the turning-off time of the second and third water supply valves 53 and 54 exceeds a predetermined time (T2: a value variously selected from a table stored in the control unit, wherein T2 is selected as approximately 10 seconds in the embodiment of FIG. 4) (S150). When it is determined that the turning-off time exceeds the predetermined time (T2), the level of the rinsing water supplied to the tub 20 through the first, second, and third water supply pipes 41, 51, and 52 is sensed (S160).

The optimum turning-on/off times of the second and third water supply valves 53 and 54 may be set by various combinations. For example, in one embodiment, the predetermined times (T1 and T2) stored in the control unit 130 are respectively set to 10 and 5 seconds and the number of repetitions of the turning-on and turning-off of the second and third water supply valves 53 and 54 per minute is increased.

After the second and third water supply valves 53 and 54 are turned on and off one time, the water level in the tub 20 is sensed, and it is determined whether the sensed water level reaches a predetermined water level for rinsing (S170). As a result of the determination, when the sensed water level does not reach the predetermined water level, the process is returned to the operations S120 and S121. That is, after the first water supply valve 42 is continuously turned on and the second and third water supply valves 53 and 54 are turned on, the above operations are repeated. Alternatively, when the sensed water level reaches the predetermined water level, the first, second, and third water supply valves 42, 53, and 54 are turned off (S180), the supply of the rinsing water is terminated, and the rinsing operation is performed (S190).

Thereafter, rinsing, dehydrating, and/or drying operations are partially or completely performed according to the selected operation data, and the steam washing procedure is terminated.

As described above, the second and third water supply valves 53 and 54 are alternately turned on and off so that water intermittently flows. Thereby, an instantly effective current of water washes the steam generation channel 82 of the steam generator 80, preventing components that generate scale from being deposited on the inner wall of the steam generation channel 82, and thus preventing the generation of scale. The water that has passed through the steam generator 80 after washing the steam generation channel 82 flows into the tub 20 through the second connection pipe 55. Accordingly, the supply of rinsing water and the washing of the steam generation channel 82 are carried out simultaneously. That is, since the rinsing water is supplied to the tub 20 through the first, second, and third water supply pipes 41, 51, and 52, the time to supply the rinsing water is shortened.

When the steam generator 80 is operated, the second water supply valve 53 that has a relatively small opening degree (see above) is used to obtain an optimum steam generating effect. On the other hand, when the channel washing operation is performed, the third water supply valve 54 that has a relatively large opening degree (see above), as well as the second water supply valve 53, is used to supply water to the steam generation channel 82 at an elevated pressure, thus preventing the generation of scale and removing the generated scale.

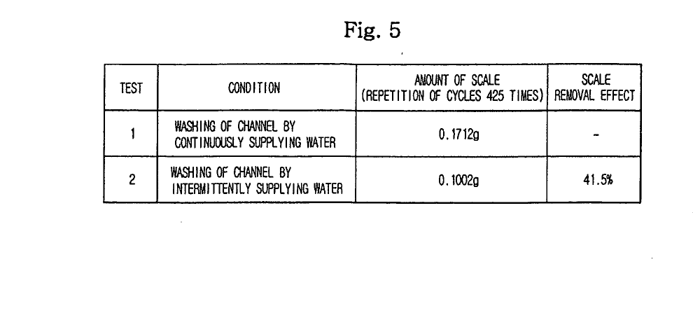

FIG. 5 is a table stating a scale removal effect of the method to control the washing machine of an embodiment of the present invention, compared to a method to control a conventional washing machine.

As shown in FIG. 5, in Test 1, after a steam supplying operation (preheating for 20 seconds and turning-on and turning-off of water supply valves for 4 and 5 seconds are repeated for 10 minutes) is performed using water having a hardness of 150 ppm, and a channel washing operation to wash a steam generator is performed by a continuous water supplying method, the amount of scale generated is measured. In Test 2, after the same steam supplying operation as that of Test 1 is performed using water having the same hardness, and a channel washing operation to wash a steam generator is performed by an intermittent water supplying method (turning-on and turning-off of water supply valves for 20 and 10 seconds are repeated for 1 minute), the amount of scale generated is measured.

As a result of repetition of 425 cycles, each of which consists of the steam supplying operation and the channel washing operation, the amount of scale of Test 1 was 0.1712 g and the amount of scale of Test 2 was 0.1002 g, as shown in FIG. 5. That is, the channel washing operation performed by intermittently supplying water in Test 2 has a scale removal effect that is approximately 41.5% higher than the scale removal effect of the channel washing operation performed by continuously supplying water in Test 1.

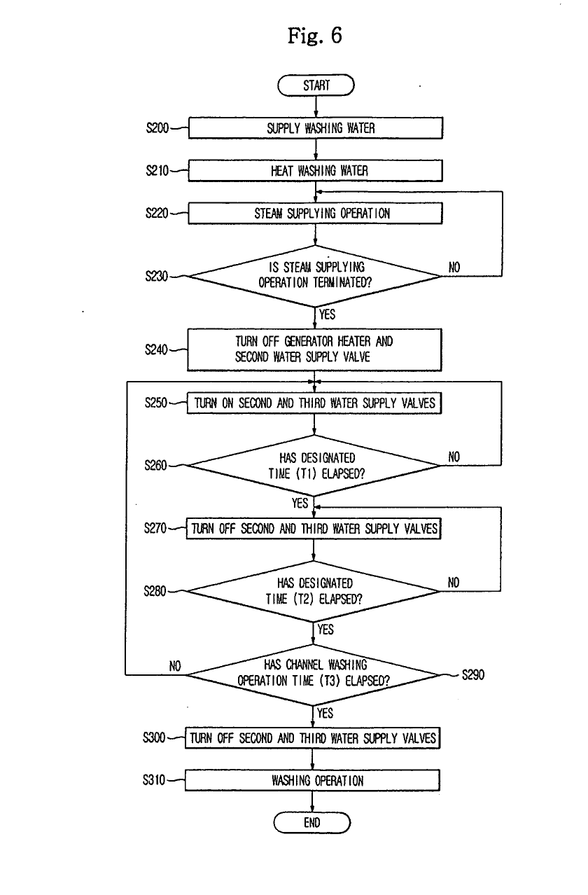

FIG. 6 is a flow chart illustrating a method to control a washing machine in accordance with another embodiment of the present invention.

In the method of the embodiment of FIG. 6, in the same manner as the method of the embodiment of FIG. 4, when a steam washing procedure is selected under the condition that laundry is put into the rotary drum 30 and a detergent is supplied to the detergent supply device 70, and the washing machine is operated, the control unit 130 turns on the first water supply valve 42 of the first water supply unit 40 to supply water to the detergent supply device 70 through the second water supply pipe 41 (S200).

Then, the detergent in the detergent supply device 70 dissolves in the washing water supplied to the tub 20 via the detergent supply device, and is supplied to the tub 20.

After the supply of the water is completed, the heater 24 is operated, and the heater 24 heats the washing water filling the tub 20 to a temperature required to wash the laundry (S210).

When the washing water is heated to the temperature required to wash the laundry, the rotary drum 30 is rotated at a reduced speed by the motor 12, thus washing the laundry.

Since a user selects a steam washing procedure, a steam supplying operation is performed (S220). The control unit 130 turns on the second water supply valve 53 so that the washing water is supplied to the steam generator 80 through the second water supply pipe 51, and when the washing water supplied to the steam generator 80 passes through the steam generation channel 82, the washing water is instantly heated by the generator heater 83, and is converted into steam of an effective temperature of 100° C. or more.

The steam of the effective temperature is supplied to the inside of the tub 20 through the second connection pipe 55 and the discharge nozzle 57. Then, the washing water and the laundry in the tub 20, which were heated by the heater 24, are heated again by the steam.

Thereafter, it is determined whether the steam supplying operation is terminated by checking whether a steam supplying time set by a user has elapsed (S230). When it is determined that the steam supplying operation is terminated, the generator heater 83 and the second water supply valve 53 are turned off (S240). To perform a channel washing operation immediately after the steam supplying operation, the second water supply valve 53 is continuously turned on, and only the generator heater 83 is turned off.

In the method of the embodiment of FIG. 6, the channel washing operation (S250, S260, S270, and S280) is performed immediately after the steam supplying operation.

Therefore, the second and third water supply valves 53 and 54 are turned on, and thus, the second and third water supply pipes 51 and 52 are opened (S250). The control unit 130 checks a turning-on time of the second and third water supply valves 53 and 54, and determines whether the turning-on time of the second and third water supply valves 53 and 54 exceeds a predetermined time (T1: a value variously selected from a table stored in the control unit, wherein T1 is approximately 20 seconds in the embodiment of FIG. 6) (S260). When it is determined that the turning-on time exceeds the predetermined time (T1), the control unit 130 turns off the second and third water supply valves 53 and 54 (S270).

Thereafter, the control unit 130 checks a turning-off time of the second and third water supply valves 53 and 54, and determines whether the turning-off time of the second and third water supply valves 53 and 54 exceeds a designated time (T2: a value variously selected from a table stored in the control unit, wherein T2 is approximately 10 seconds in the embodiment of FIG. 6) (S280). When it is determined that the turning-off time exceeds the predetermined time (T2), the control unit 130 determines whether a channel washing operation time (T3: a value variously selected from a table stored in the control unit, wherein T3 is approximately 1 minute in the embodiment of FIG. 6) has elapsed (S290).

When it is determined that the channel washing operation time has not elapsed, the process is returned to the operation S250. That is, after the second and third water supply valves 53 and 54 are turned on, the above operations are repeated.

Alternatively, when it is determined that the channel washing operation time has elapsed, the second and third water supply valves 53 and 54 are turned off, and a washing operation is performed (S310).

As described above, in the embodiment of FIG. 6, the channel washing operation is performed immediately after the steam supplying operation, i.e., immediately after the operation of the steam generator 30 is terminated, thus removing the residual water of an elevated temperature in the steam generation channel 82 and rapidly cooling the steam generator 80. Thereby, scale deposited on the inner wall of the steam generation channel 82 is more effectively removed.

As is apparent from the above description, the present invention provides a washing machine, in which a heater is turned off after the supply of steam to the inside of a rotary drum, and water is intermittently supplied to a steam generator, and a method to control the washing machine, thus preventing generation of scale on the inner wall of a steam generation channel and removing generated scale.

Further, embodiments of the washing machine of the present invention include water supply pipes and water supply valves to supply water at an elevated pressure and a flow velocity in a channel washing operation that are greater than a pressure and flow velocity in a steam supplying operation, thus improving a scale removal effect.

Although embodiments of the invention have been shown and described, it would be appreciated by those skilled in the art that changes may be made in these embodiments without departing from the principles and spirit of the invention, the scope of which is defined in the claims and their equivalents.

What is claimed is:

1. A washing machine, which has a rotary drum, a steam generator having a generator heater to supply steam to an inside of the rotary drum, and a water supply device to supply water to the steam generator, including:
a control unit controlling the water supply device to pass water intermittently through the steam generator to cool the steam generator when operation of the steam generator is terminated.

2. The washing machine according to claim 1, wherein:
the water supply device includes water supply pipes connecting the steam generator and a water supply source, and water supply valves to open and close the water supply pipes; and
the control unit turns on and off the water supply valves alternately.

3. The washing machine according to claim 2, wherein the water supply pipes are a pair of water supply pipes, and are united and connected to the steam generator.

4. The washing machine according to claim 1, wherein the control unit turns off the generator heater when the operation of the steam generator is terminated.

5. The washing machine according to claim 3, wherein the pair of water supply valves arranged to open and close the water supply pipes, and have different opening degrees.

6. The washing machine according to claim 1, wherein the steam generator includes a steam generation channel, through which water passes to generate the steam, and the steam generation channel is made of a non-stick material.

7. The washing machine according to claim 5, wherein the control unit turns off the water supply valve having a larger opening degree in the pair of the water supply valves when the steam generator is operated.

8. The washing machine according to claim 7, wherein the control unit turns on both the water supply valves in the pair of water supply valves or a water supply valve having a larger opening degree in the pair of the water supply valves when the steam generator is cooled.

9. A washing machine, which includes a water supply device, a rotary drum, and a steam generator to supply steam to an inside of the rotary drum,
wherein the steam generator includes a steam generation channel, through which water passes to generate the steam, a generator heater to evaporate the water in the steam generation channel, and a control unit turning off the generator heater and turning on/off the water supply device to supply water intermittently to the steam generation channel to prevent the deposition of scale in the steam generation channel.

10. A method to control a washing machine which has a rotary drum and a steam generator having a generator heater to supply steam to an inside of the rotary drum, comprising:
performing a steam supplying operation to supply the steam, which is generated by operating the steam generator, to the rotary drum; and
performing a channel washing operation to supply water intermittently to the steam generator, after the steam supplying operation is terminated, to prevent deposition of scale on the steam generator.

11. The method according to claim 10, wherein the channel washing operation includes turning off the generator heater.

12. The method according to claim 10, wherein water supply valves are alternately turned on and off in the channel washing operation.

13. The method according to claim 10, wherein:
water supply pipes in a pair are united and connected to the steam generator to supply water to the steam generator, and a pair of water supply valves having different opening degrees are respectively located in the water supply pipes; and
a water supply valve having an opening degree that is smaller than an opening degree of another water supply valve of the pair of water supply valves is turned on so that water passes through the steam generator in the steam supplying operation.

14. The method according to claim 13, wherein both the water supply valves in the pair or the water supply valve having a larger opening degree than the opening degree in another water supply valve in the pair of the water supply valves is turned on to allow water to pass through the steam generator in the channel washing operation.

15. The method according to claim 10, wherein the channel washing operation is performed when water for rinsing is supplied.

16. The method according to claim 10, wherein the channel washing operation is performed before a washing operation is terminated.

17. The method according to claim 10, wherein water passes through the steam generator at a pressure in the channel washing operation that is greater than a pressure in the steam supplying operation.

18. The washing machine of claim 1, wherein a single water supply pipe is connected to the steam generator, and a single water supply valve having an adjustable opening degree is located in the water supply pipe.
